(19) United States
(12) Patent Application Publication
(10) Pub. No.: US 2006/0080726 A1
(43) Pub. Date: Apr. 13, 2006

(54) Method and apparatus for determining controlller authorizations in advance

(76) Inventors: Maarten Peter Bodlaender, Eindhoven (NL); Hugo Wilhelmus Jacobus Zonneveld, Schagen (NL); Sebastiaan Antonius Fransiscus Arnoldus Van Den Heuvel, Eindhoven (NL); Robert Paul Koster, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/546,318

(22) PCT Filed: Feb. 25, 2004
(86) PCT No.: PCT/IB04/50146

§ 371 Date: Aug. 19, 2005

(30) Foreign Application Priority Data
Feb. 27, 2003 (EP) 03075589.6
Oct. 14, 2003 (EP) 03103791.4

(51) Int. Cl. H04L 9/32

(52) U.S. Cl. 726/2

(57) ABSTRACT

The present invention relates to a method, for a controller (103) for invoking actions on a device (105), of determining which actions are authorized to be invoked on said device (105). The controller (103) is adapted for invoking actions on the device (105) by sending an action command (A1, A2, A3, A4) to said device (105). Each of said predefined action commands (A1, A2, A3, A4) can be sent to invoke a specific action on the device (105). The method comprises the step of transmitting an checking-checking query (107, 109, 111, 113) to determine authorizations related to at least one of said actions that can be invoked on the device (105) by said action commands. The method further comprises the step of receiving an indication (115, 117, 119, 121) of authorizations related to the at least one of said actions being invoked on the device (105). Thereby a controller can know in advance, which actions are authorized to be invoked on the device. It can use this information in a variety of ways, one is to inform a user, which actions are available, and which options are not available, another is to plan ahead for a sequence of actions. Authorization can be related to the available rights for DRM protected content being processed by the device or to authorizations related to the controller.

The present invention relates to a method, for a controller for invoking actions on a device, of determining, which actions are authorized to be invoked on said device. The invention also relates to a controller for invoking actions on a device. The invention further relates to a control point to be positioned in an UPnP network for invoking actions on UPnP devices in the UPnP network.

Today a number of technologies exist, where a first device is adapted to invoke actions on a second device. In this situation the first device would be a controller controlling the second device. Such technology is used in a number of applications such as standard computer networks, either at home or within the industry, or in situations where a remote controller is used for controlling home appliances such as televisions, videos or industrial appliances.

In situations where a controller controls a device, the controller is adapted to invoke actions on the device by transmitting action commands to the device via a communication channel being e.g. wireless. Not all actions might be authorized to be invoked on the device, such authorizations could be based on DRM (Digital Right Management) applied to content being processed by the device. An example of DRM content could be a multimedia content, which is only authorized to be played back, but not recorded. Further examples could be contents that may be rendered for a limited number of times or only during a certain time period, or when the person who bought the content is operating the rendering device. Another example of authorization limitations could be authorizations related to the controller e.g. in an UPnP network as described below.

“Universal Plug and Play (UPnP)” is an architecture for pervasive peer-to-peer network connectivity of intelligent appliances, wireless devices, and PCs of all form factors. It is designed to bring easy-to-use, flexible, standards-based connectivity to ad-hoc or unmanaged networks whether in the home, in a small business, public spaces, or attached to the Internet Universal Plug and Play is a distributed, open networking architecture that leverages TCP/IP and the Web technologies to enable seamless proximity networking in addition to control and data transfer among networked devices in the home, office, and public spaces. The UPnP standard is defined in the document “Universal Plug and Play Device Architecture”, Version 1.0, Jun. 8, 2000, (c) 1999-2000 Microsoft Corporation.

The Universal Plug and Play (UPnP) security standard is defined as an add-on to UPnP 1.0. It defines how access control can be added and managed in an UPnP network. Specifically, actions that are invoked by control points can now be refused because control points are not authorized. The UPnP security standard consists of four documents. One document describes a ‘Secure Device’ and gives an overview of the standard. The other three documents describe one mandatory service ‘Device Security’ and two optional services ‘Secure Console’ and ‘Device Stealth’.

A UPnP network could comprise three UPnP security components: a security-aware Control Point, a security-aware UPnP device and a Security Console. The security-aware UPnP device has an Access Control List (ACL), in which permissions of Control Points for performing services on the specific UPnP device are stored. The Security Console performs the administration of the Access Control List. This UPnP security component has a user interface, by which the owner of the network can control the Security Console and grant permissions to control points. These three security components are logical entities, and a single physical device can implement any number of them.

Typically, control points are part of devices that interact directly with the end-user. For example, in Philips iPronto advanced remote control prototypes shown to Philips customers in the CES world tour, the iPronto acts as a control point, and is able to control all devices in the network. With the addition of UPnP security, it can occur that such a device is no longer authorized to fully control all devices, but can control only a subset of all devices and all functionalities of the devices. In this case, it would be beneficiary if the user interface reflects this. For example, if a user is not permitted to control a certain device, this would be indicated in the user interface (e.g. by greying out the device, not showing it at all, pictogram with a lock, etc.). Without such an indication, a user will attempt to control the device and will fail, which will be perceived by the users as low quality.

To visualize to the user what actions are permitted, a control point has to somehow establish in advance what its permissions are. With the current UPnP security standard two problems are preventing this:

1. Permissions are Not Standardized

This is clear when reading page 9 of SecureDevice: “However, the mapping between permissions and protocol-level entities such as services and actions is not standardized.”

“Devices are free to define their own permissions and use whatever mechanism they wish to map incoming control requests onto required permissions.”

The UPnP security standard has refrained from specifying a fixed set of permissions. Instead, each device vendor can specify a proprietary set of permissions. Users can select these permissions by selecting a string. A tool tip and web page in natural language explains to users what the permissions mean. This is not machine-readable, so a control point cannot deduce, which actions are permitted, and which are not permitted from this information.

One of the reasons for not standardizing permissions is that a wide variety of permissions are possible if granting access is dependent on the current context. For example, a permission could be “daytime only”. Such permission would grant access or forbid access, depending on the time of day. Coming up with a standard, which covers all possible scenarios foreseen by different vendors, and which is still compact and easy to implement, is hard. Furthermore, not standardizing these permissions makes it easy to extend the system, thus making it future proof.

2. The ACLVersion May not be Sent to Control Points

As is clear when reading page 8 of DeviceSecurity, the ACLVersion may not be sent to control points. More specifically, on page 23 of this document the action read ACL is defined in the section “actions invoked by SC only”, where SC is Security Console. Specifically, no information on granted permissions and corresponding authorized actions flows from the Security console and the secure device to the control points.

In U.S. 2002/0027569 it is described how a user control point tool is used for allowing generic discovery, control, and display of Universal Plug and Play devices from a common user interface. This generic UCP tool provides a common user experience for all UPnP devices, regardless of their individual manufacturers. The generic UCP tool allows discovery of UPnP devices by type, by unique device name, or asynchronously. The user may select one of the discovered devices, view its properties, and select one of the services provided for that device to control. Additional information from a service description document may be viewed, and a user may query the value of the state variables and invoke an action for a service for the selected UPnP device. The results of the action are displayed on the tool's UI, as is the evening information for the UPnP device. Status information for operation of the generic UCP tool itself is also provided. The document does not describe how to handle security issues ensuring that only authorized commands can be given from the control point to the UPnP devices and that the authorizations are initially presented to the user.

It is therefore an object of the present invention to obtain a method of determining, for a controller controlling a device, which action commands it is authorized to invoke on the device. Further, it is an object to obtain a method of determining, for a control point in an UPnP network, which action commands and action command parameters it is authorized to invoke on the other UPnP devices in the UPnP network. These authorizations should be obtained in a way, which overcomes the above UPnP defined demands, while maintaining the advantages of extensibility and future-proofness.

This is obtained by a method, for a controller for invoking actions on a device, of determining, which actions are authorized to be invoked on said device, where the controller is adapted for invoking actions on the device by sending an action command from a set of predefined action commands to said device, where each of said predefined action commands can be sent to invoke a specific action on the device, and the method comprises the steps of:
transmitting an checking-checking query to determine authorizations related to at least one of said actions that can be invoked on the device by said action commands, and
receiving an indication of authorizations related to the at least one of said actions being invoked on the device.

Thereby a controller can know in advance, which actions are authorized to be invoked on the device. It can use this information in a variety of ways, one is to inform a user, which options are available, and which options are not available, another is to plan ahead for a sequence of actions. A further advantage is that a controller needs not be aware of the types of permissions that can be granted. Thus, when the set of defined permissions is extended or changed, for example in new versions of a device, the controller need not be updated. This makes the controller more future-proof.

An action can be any functionality that can be performed by the device, and if for example the device is a combined DVD recorder/player, then the actions performed by the device could be related to the record functionality of the combined DVD recorder/player, and the actions could include actions such as record at a specific time, record specific content or record of specific content at a specific time. The actions could further include actions related to the play command being play at specific time or play specific content.

The checking-checking query could be a query checking authorization for invoking one or more specific actions on the device. This could be by either sending a query related to each action command in the set of predefined actions commands or by sending a query relating to a group of action commands. Alternatively, the authorization checking query could be a query to determine, what is authorized to be invoked on the device, and based on the response it can be determined, which of the predefined action commands are authorized to be invoked on the device.

The authorization of actions to be invoked could e.g. be based on available DRM rights related to the content. Alternatively, it could be related to rights of the controller e.g. in an UPnP network. Different controllers could have different rights, and thereby be authorized to invoke different sets of actions on the device. The authorizations could be determined by the device and transmitted to the controller. In an example where the controller is controlling a sink device for processing DRM protected data from a source device, the controller could obtain the DRM specific information from the source device. Next the DRM specific information is passed to the sink device, and using this DRM specific information the authorizations relating to the actions are returned to the controller.

In a specific embodiment the method further comprises the step of, based on the received indication, indicating for the user of the controller the authorizations related to the at least one of said actions being invoked on the device. Thereby the user knows its authorizations before invoking a command, which ensures that the user can invoke actions and not surprisingly receive a denial from the device. This improves the quality of the user's experience when using the controller.

In an embodiment the indication received by the controller is an indication that the action can be invoked on said device if predefined conditions are fulfilled. Thereby a controller knows that a certain action might fail if conditions are not met. It can indicate this to a user, and thus prepare a user for potential authorization failure. Apart from user expectation management, a user might also then decide to not select the option. In addition, in planning a sequence of commands it can plan for failure scenarios, or select different actions that are fully authorized.

In a specific embodiment the predefined conditions are identified by the indication. The advantage of this is that a controller can (repeatedly) compute when the conditions are met. It can use the result of these computations in its user interface and planning processes. The controller can also communicate these conditions to a user, who can choose this option if the user knows that the conditions are met.

In an embodiment the controller receives a new indication of authorizations related to the at least one of said actions being invoked on the device, if the authorizations change. User interaction with a device is typically a continuous and interactive process. If a user detects that a certain desired action is not authorized, the user can act to get authorization for the controller, for example by manually activating commands on another device. Once the authorization is granted, the user would expect that this is reflected in the user interface of the controller. The method described above enables this, since the controller is notified on authorization changes. Furthermore, a controller can also implement program logic that changes behavior depending on the available authorization. For example, a program might become active once all required authorizations are available.

In an embodiment the device is adapted for processing data, and the indication of authorizations related to the at least one of said actions being invoked on the device is based on authorizations related to said data. Often authorizations are related to data, e.g. when the data is DRM protected content, and these authorizations should be taken into consideration when determining, which actions a controller adapted to control a device is authorized to invoke on said device. Authorizations based on DRM could e.g. be authorizations related to the context of the device processing the data, e.g. the time, the current user operating the device or the region of the world.

In an embodiment the indication of authorizations related to the at least one of said actions being invoked on the device is based on authorizations related to the controller. One controller might have authorizations to invoke a larger set of actions on a device than another controller.

In an embodiment the controller is a control point in a UPnP network, and the device is an UPnP device being part of the UPnP network. Today there is no way in the current UPnP security standards for an UPnP control point to know in advance whether it is authorized to invoke a secured action. This functionality is also absent in the current UPnP A/V standard that works on multimedia content including DRM protected content. This present invention adds this functionality.

In an embodiment the authorization query is made by transmitting an authorization command, where an authorization command corresponds to a single predefined action command. This is an easy way of uniquely querying authorization for a specific command.

In another embodiment the authorization query is made by transmitting an authorization command, where the command argument is a string argument comprising a SOAP-marshaled version of an action command indicating the action command for which authorization is queried. Thereby a single action suffices to test all available actions.

The invention further relates to a controller for invoking actions on a device, where the controller is adapted for invoking actions on the device by sending an action command from a set of predefined action commands to said device, where each of said predefined action commands can be sent to invoke a specific action on the device, and the controller comprises:

means for transmitting an checking-checking query to determine authorizations related to at least one of said actions that can be invoked on the device by said action commands, and

means for receiving an indication of authorizations related to the at least one of said actions being invoked on the device.

In a specific embodiment the controller further comprises means for, based on the indication received from the device, indicating for the user of the controller the authorizations related to the at least one of said actions being invoked on the device.

The invention also relates to a control point to be positioned in a UPnP network for invoking actions on UPnP devices in the UPnP network, where the control point is adapted for controlling the UPnP devices in the UPnP network by sending at least a set of predefined action commands to at least one of said UPnP devices, where each of said predefined action commands are sent to invoke a specific action on the UPnP device, and the control point comprises:

means for transmitting an checking-checking query to determine authorizations related to at least one of said actions that can be invoked on the UPnP device by said action commands, and

means for receiving an indication of authorizations related to the at least one of said actions being invoked on the UPnP device.

In the following preferred embodiments of the invention will be described referring to the Figs., where:

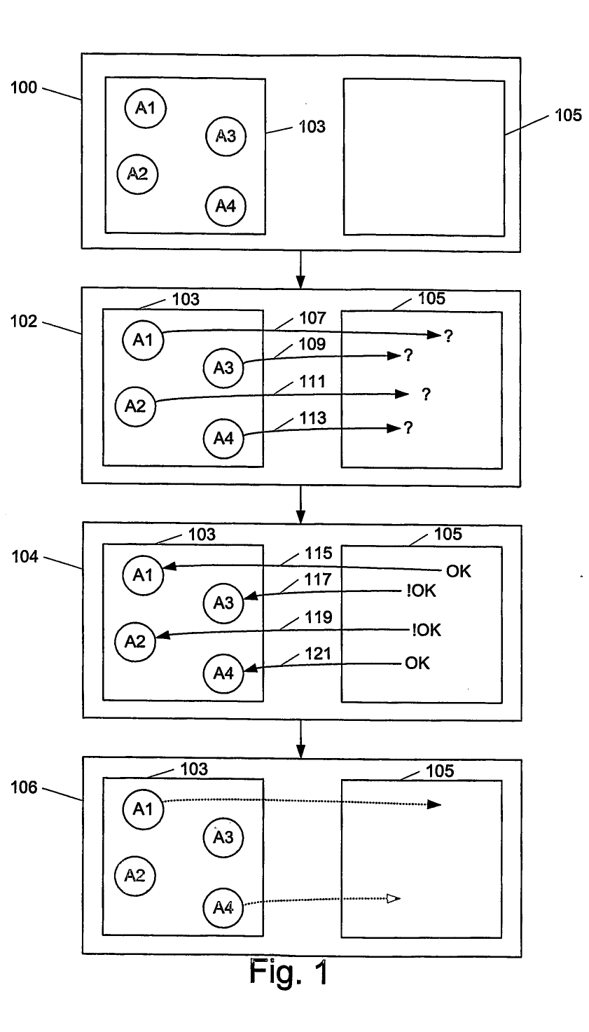

FIG. 1 is a schematic illustration of a controller determining, which actions are authorized to be invoked on a device, where the device indicates an authorization,

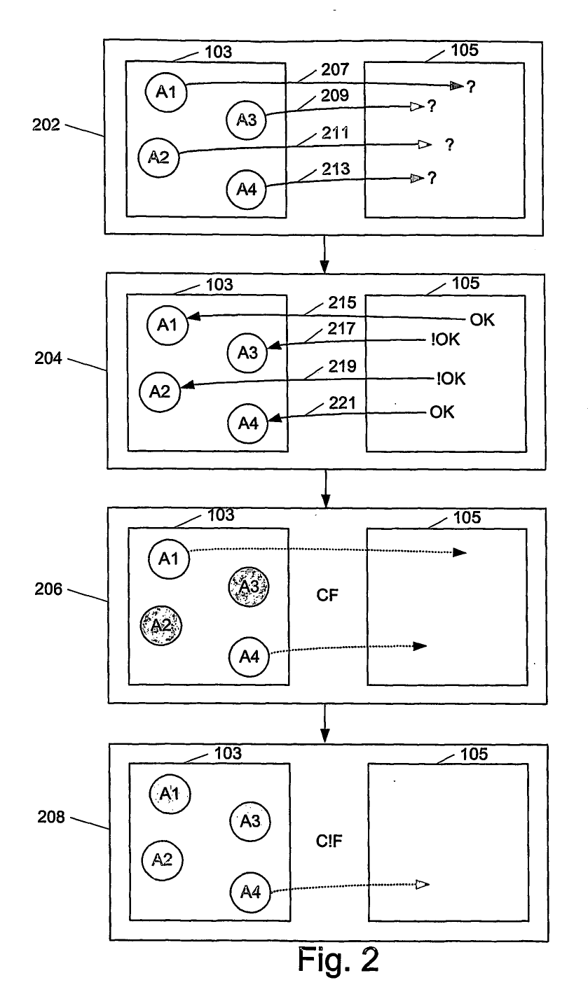

FIG. 2 is a schematic illustration of a controller determining, which actions it is authorized to invoke on a device, where the device indicates a conditioned authorization,

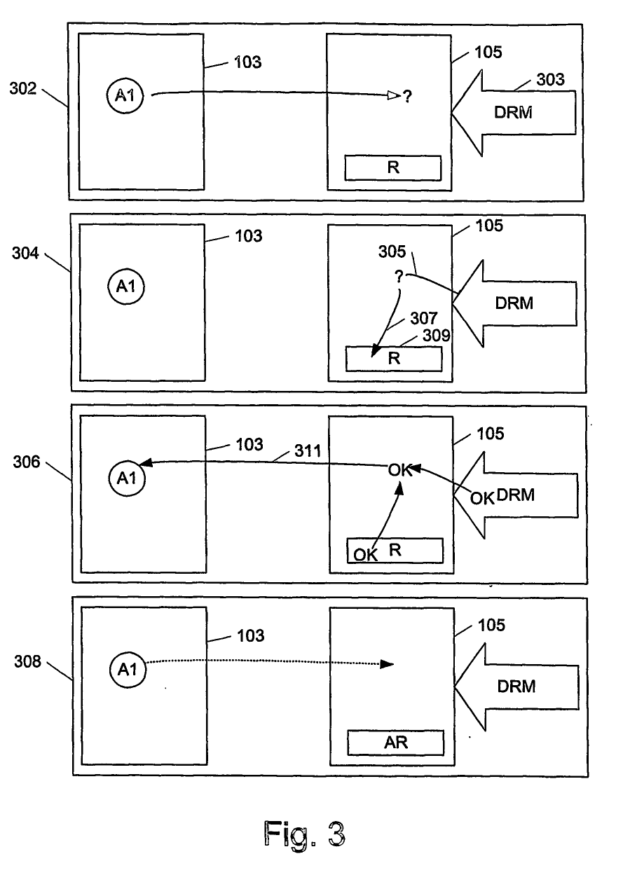

FIG. 3 illustrates an example, where the authorization of actions on a device for processing content is based on DRM protected content,

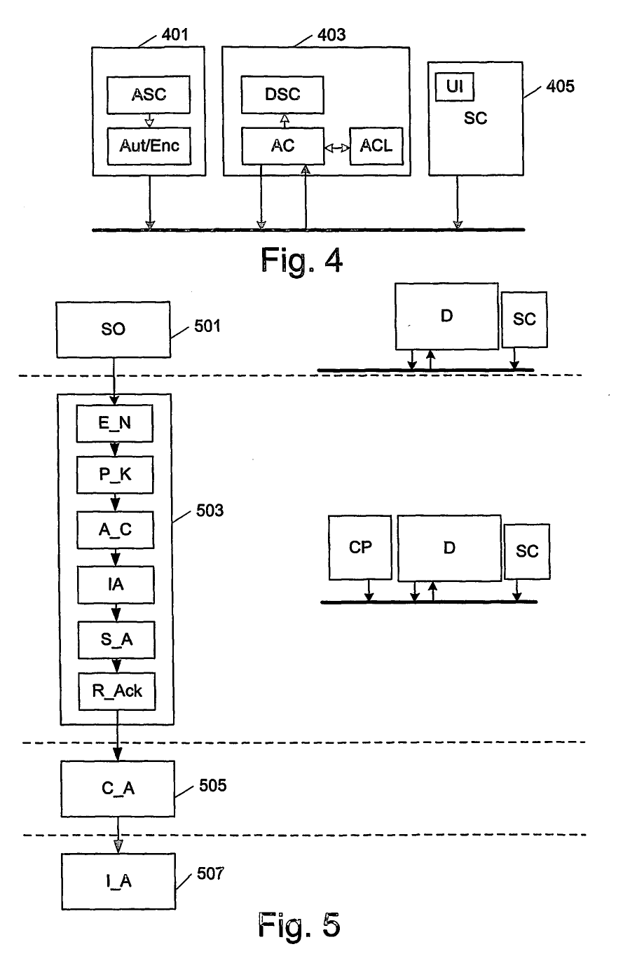

FIG. 4 illustrates a UPnP network comprising three types of UPnP components, one being a control point for controlling a UPnP device,

FIG. 5 is a diagram illustrating the process of setting up a control point in a UPnP network, where the control point determines its authorizations according to the present invention.

In FIG. 1 a schematic illustration of a controller 103 determining, which actions are authorized to be invoked on a device 105 is shown. In the example as shown in 100, the controller 103 has a set of predefined action commands A1, A2, A3, A4, which can be used to control the device 105, but the controller 103 might not have authorizations to invoke all the action commands on the device 105, or all the actions might not be authorized to be invoked on the device. According to the invention, the controller 103 therefore checks the authorizations when controlling the device 105. This authorization check is performed by initially sending an checking-checking query 107, 109, 111, 113 to the device as shown in 102, where each checking-checking query 107, 109, 111, 113 is action command specific, and therefore corresponds to one of the action commands in the set of predefined action commands A1, A2, A3, A4. Furthermore, this checking-checking query can include specific parameter values. In 104 the device 105 has received the query, and it then responds to the controller 103 with an indication 115, 117, 119, 121 of authorizations related to the corresponding action commands A1, A2, A3, A4 being invoked on the device 105 by the controller 103. In the case that a parameter value range is indicated, or parameter values are omitted, the returned result can be “authorization depending on parameter values”, “authorized” or “not authorized”. The “depending on parameters” return value indicates that the controller 103 has authorizations for part of the range of parameter values. In the example illustrated in FIG. 1 the indication received from the device 105 is that the action commands A1 and A4 are authorized (OK) to be invoked on the device 105 by the controller 103, whereas the action commands A3 and A2 are not authorized (OK) to be invoked on the device 105. In 106 the controller knows which action commands can be invoked on the device 105, and these can be invoked with success when necessary. The controller 103 will not try to invoke the action commands A2 and A3, since it has received information from the device 105 that it has only authorization to invoke the action commands A1 and A4.

Instead of checking authorization for each specific action command, the controller could also check authorizations of a group of action commands, these groups could e.g. be based on the type of command. An example of this could be when a controller controls a device with a storage medium, then one group of commands could be action commands invoking actions involving writing on the medium, whereas another group could be action commands invoking actions only involving reading from the storage medium. An action command invoking an action could comprise parameters e.g. defining how or when an action is to be invoked. Furthermore, action A1, A2, A3, A4 might be authorized to be invoked on the device 105 by the controller 103, but the actions might not be authorized to be invoked with the entire range of possible input parameters. For example, the action A1 might have an integer input parameter P1, and might only be authorized to be invoked for values of P1 smaller than a defined boundary B1.

The authorizations could be pre-stored on the device 105, and based on e.g. the ID of the controller 103 the device 105 can determine the authorizations of the controller 103. Alternatively, the authorization of any unidentified controller for controlling the device 105 could be the same, and based on the command specific authorization-checking query from the controller, the device 105 is able to determine the action command authorization and give the authorization indication to the controller. Further, the authorizations could be related to the data to be processed by the device 105, e.g. when the data is DRM managed content. In this case the authorizations need not to be pre-stored but could be delivered as part of the data.

In the above example the controller received information of whether specific actions were authorized to be invoked on the device by the controller, and the actions were either allowed or not allowed. In general, the authorization could also be conditioned as illustrated in the simplified illustration of FIG. 2. Initially, the controller 103 has a set of predefined action commands A1, A2, A3, A4 which can be used to control the device 105. The controller 103 therefore checks, which actions are authorized to be invoked on the device 105 when controlling the device 105. Again the authorization check is performed by initially sending an checking-checking query 207, 209, 211, 213 to the device as shown in 202. In 204 the device 105 has received the query, and it then responds to the controller 103 with an indication 215, 217, 219, 221 of whether the specific action is authorized to be invoked on the device 105 by the controller 103. In this example the controller is only authorized to invoke the action relating to the action command A1 when a condition is fulfilled, so therefore only a conditioned authorization (C_OK) is given to the controller 103. The condition could be that the action can only be invoked in specific time intervals, or that it can only be invoked when one or more predefined actions have been invoked previously. If the action command invoking an action comprises parameters defining how, on what or when an action is to be invoked, then the condition could also be that an action is only authorized to be invoked when specific arguments are used. In 206 the condition is fulfilled (CF), and the controller 103 will not try to invoke the action commands A2 and A3, whereas in 208 the condition is not fulfilled (C!F), and the controller will not try to invoke the action commands A1, A2 and A3.

In FIG. 3 it is illustrated how authorization related to an action A1 is checked in order to determine whether the action A1 is authorized to be invoked on a device 105 by a controller 103. In the example the device is a device for processing multimedia content from either a broadcasted signal, such as a home network, the Internet or cable, or from a storage medium, such as DVD or CD. The multimedia content is illustrated by the arrow 303, and the data is DRM protected. The action A1, which is checked, could be the record action, which, when being invoked on the device, results in the device starting to record the multimedia content on a storage medium. In 304 the device 105 has received the query, and it checks authorizations related to the action A1. This check is performed by checking respectively the rights 305 related to the content to be recorded, resulting in knowledge related to whether it is authorized to record the multimedia content. Further, the check could include checking 307 whether the specific controller 103 is authorized to invoke the action, which could be locally stored rights 309 e.g. stored as an access control list (ACL) in the device 105. In 306 the result of the authorization check related to respectively the multimedia content and the controller 103 is that the controller 103 is authorized (OK) to invoke the action A1 on the device 105. The device 103 then responds to the controller 103 with an indication 311 that the specific action is authorized In 308 the controller knows that the action command A1 can be invoked on the device 105, and it can be invoked with success when necessary. In the case of DRM protected content being processed by the device 105 it would be necessary to check the command again, when new content is to be processed by the device 105.

In the above the invention has been described in general terms. The invention can be used advantageously by control points in connection with UPnP networks.

In FIG. 4 an UPnP network is illustrated comprising three types of UPnP components, one being a security aware control point 401 for controlling a UPnP device 403. The security aware control point 401 comprises some application specific codes (ASC) enabling the control point to perform different applications. These applications can communicate with the UPnP devices on the UPnP network via an authentication/encryption unit (Aut/Enc). The UPnP network further comprises a security-aware UPnP device 403 and a security console 405. The security-aware UPnP device 403 comprises an Access Control List (ACL), in which permissions of control points 401 for performing services on the specific UPnP device are stored. The Access Control List (ACL) is used by the access control (AC) in the UPnP device 403. The UPnP device further comprises some device specific codes (DSC) enabling the functionality of the UPnP device. The security console 405 performs the administration of the Access Control List (ACL). This UPnP security component has a user interface (UI), by which the owner of the network can control the security console 405 and grant permissions to control points. These three security components 401, 403, 405 are logical entities, and a single physical device can implement any number of them.

FIG. 5 is a diagram illustrating the process of setting up a control point in a UPnP network, where the control point determines its authorizations according to the present invention. In the description the control point 401 will be referred to as CP, the UPnP device 403 will be referred to as D and the security consol will be referred to as SC.

First in 501 only the security consol SC and the UPnP device D are present in the UPnP network, and the security console takes ownership of the UPnP device, meaning that the security console can authorize control points in the network to access the UPnP device D. In a specific embodiment the security console and the UPnP device might be the same physical device. One way of taking control in a secure way is by requiring that the security console knows a secret of the UPnP device, this secret could e.g. be code written in the manual of the UPnP device. Alternatively, the control could be taken by establishing a secure channel (e.g. via a USB cable) between the security console and the UPnP device.

Next in 503 the control point enters the network and obtains authorization, this comprises the following steps:

The security aware control point enters the network (E_N) and discovers the presence of all security consoles. Next the security aware control point provides all security consoles with its key P_K. Then security consoles authorize the control point on any device, and in parallel the security-aware control point can detect the UPnP device and detect that it needs permissions to access it A_C. Next in the box named IA, the security console could either interact with an end-user and the UPnP device providing the end-user with authorization options, optionally the security console interacts with a third authorization server (delegation). As a further option the security console inspects certificates provided by the control point. Then the security console sets authorization (S_A) on the UPnP device, and finally the security console returns acknowledgement to the control point. As an alternative acknowledgement can be returned before authorization is granted.

Now in 505 the control point checks authorization on specific action commands, this could be done by, for each action command, checking authorization on the UPnP device. Optionally, the control point further registers for events on changes to authorization on the actions on the UPnP device.

The control point now has knowledge about which of the actions related to the predefined action commands it has authorization to invoke on the UPnP device, and in 507 it can start invoking actions on the UPnP device knowing that they are authorized. This invoking of actions could be initiated by a user to whom it has been indicated on a user interface, which actions are authorized and which are not.

In an embodiment the command specific checking-checking query can be specified uniquely for each action command. In an example the action command “DestroyObject(IN string ObjectID)” could have a corresponding matching test-action being “testDestroyObject(IN string ObjectID)”. In another embodiment a “test” action is defined with a string argument that contains a SOAP-marshaled version of an action invocation, for example “testAction(IN string SOAPAction)”. Optionally, the specific service is also added as a parameter to the action, such that the testaction( ) action can be defined in a separate service, and for example added to the DeviceSecurity document.

Examples of devices to be controlled could be a networked TV, stereo set, or door (can be opened/closed through network commands) that implement security mechanisms. The security console for performing security control could e.g. be a networked universal remote control that implements security mechanisms. Further, the controller could be a portable storage/controller device like a networked version of a hard-disk portable music player. An example where the invention is used could be as described in the following:

A guest enters the home of a friend. The guest has a new song on his portable music player and would like to play this on his friend's big stereo. The UI of the portable music player shows that a stereo is present, but that the guest is not allowed to control it. The guest asks the friend to change that. The friend changes this by taking his universal remote control, selecting the “authorizations” tab and seeing that the guest's portable music player has presented its key. The friend then selects the stereo and grants the guest's portable music player “loud guest access” for 2 hours. The guest's portable music player directly changes the user interface to show that the stereo is now available. The guest uses the UI to order the new song to be played at max volume on the big stereo. A second later the music starts playing.

It is noted that the above may be implemented as general- or special-purpose programmable microprocessors, Digital Signal Processors (DSP), Application Specific Integrated Circuits (ASIC), Programmable Logic Arrays (PLA), Field Programmable Gate Arrays (FPGA), special purpose electronic circuits, etc., or a combination thereof.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A method, for a controller (103) for invoking actions on a device (105), of determining, which actions are authorized to be invoked on said device (105), where the controller (103) is adapted for invoking actions on the device (105) by sending an action command (A1, A2, A3, A4) from a set of predefined action commands (A1, A2, A3, A4) to said device (105), where each of said predefined action commands (A1, A2, A3, A4) can be sent to invoke a specific action on the device (105), and the method comprises the steps of:
transmitting an checking-checking query (107, 109, 111, 113) to determine authorizations related to at least one of said actions that can be invoked on the device (105) by said action commands, and
receiving an indication (115, 117, 119, 121) of authorizations related to the at least one of said actions being invoked on the device (105).

2. A method according to claim 1, wherein the method further comprises the step of, based on the received indication (115, 117, 119, 121), indicating to the user of the controller (103) the authorizations related to the at least one of said actions being invoked on the device (105).

3. A method according to claim 1, wherein the indication (115, 117, 119, 121) received by the controller (103) is an indication (115, 117, 119, 121) that the action can be invoked on said device (105) if predefined conditions are fulfilled.

4. A method according to claim 3, wherein said predefined conditions are identified by the indication (115, 117, 119, 121).

5. A method according to claim 1, wherein the controller receives a new indication (115, 117, 119, 121) of authorizations related to the at least one of said actions being invoked on the device (105) if the authorizations change.

6. A method according to claim 1, wherein the device (105) is adapted for processing data, and wherein the indication (115, 117, 119, 121) of authorizations related to the at least one of said actions being invoked on the device (105) is based on authorizations related to said data.

7. A method according to claim 1, wherein the indication (115, 117, 119, 121) of authorizations related to the at least one of said actions being invoked on the device (105) is based on authorizations related to the controller (103).

8. A method according to claim 1, wherein the controller is a control point (401) in an UPnP network, and the device is an UPnP device (403) being part of the UPnP network.

9. A method according to claim 1, wherein the authorization query is made by transmitting an authorization command, where an authorization command corresponds to a single predefined action command.

10. A method according to claim 1, wherein the authorization query is made by transmitting an authorization command, where the command argument is a string argument comprising a SOAP-marshaled version of an action command indicating the action command for which authorization is queried.

11. A controller (103) for invoking actions on a device, where the controller (103) is adapted for invoking actions on the device (105) by sending an action command (A1, A2, A3, A4) from a set of predefined action commands (A1, A2, A3, A4) to said device (105), where each of said predefined action commands (A1, A2, A3, A4) can be sent to invoke a specific action on the device (105), and the controller comprises:
means for transmitting an checking-checking query (107, 109, 111, 113) to determine authorizations related to at least one of said actions that can be invoked on the device (105) by said action commands, and
means for receiving an indication (115, 117, 119, 121) of authorizations related to the at least one of said actions being invoked on the device (105).

12. A controller according to claim 11, wherein the controller (103) further comprises means for, based on the indication received from the device, indicating for the user of the controller (103) the authorizations related to the at least one of said actions being invoked on the device (105).

13. A control point to be positioned in a UPnP network for invoking actions on UPnP devices (403) in the UPnP network, where the control point (401) is adapted for controlling the UPnP devices (403) in the UPnP network by sending at least a set of predefined action commands (A1, A2, A3, A4) to at least one of said UPnP devices (403), where each of said predefined action commands (A1, A2, A3, A4) are sent to invoke a specific action on the UPnP device (403), and the control point (401) comprises:
means for transmitting an checking-checking query (107, 109, 111, 113) to determine authorizations related to at least one of said actions that can be invoked on the UPnP device (403) by said action commands, and
means for receiving an indication (115, 117, 119, 121) of authorizations related to the at least one of said actions being invoked on the UPnP device (403).
